(19) United States
(12) Patent Application Publication
(10) Pub. No.: US 2020/0269457 A1
(43) Pub. Date: Aug. 27, 2020

(54) CENTRIFUGAL-TYPE SLICER FOR SLICING FOOD

(71) Applicant: Frito-Lay Trading Company Gmbh, Berne (CH)

(72) Inventor: Greg HILLIARD, Leicester, Leicestershire (GB)

(21) Appl. No.: 16/494,282

(22) PCT Filed: Mar. 13, 2018
(86) PCT No.: PCT/EP2018/056268

§ 371 Date: Sep. 13, 2019

(30) Foreign Application Priority Data
Mar. 13, 2017 (GB) 1703986.8

(51) Int. Cl. B26D 1/03

(52) U.S. Cl. CPC B26D 1/03; A23L 19/18

(57) ABSTRACT

The present invention relates to a centrifugal-type food slicer of the kind having a cutting head comprising a plurality of blades and an impeller provided with paddles. The present invention also relates to method for slicing food using such a centrifugal-type slicer. An inclined configuration of the impeller paddles relative to a rotational axis of the impeller, cooperating with blades inclined relative to the central axis of the cutting head provides balanced turning forces on the unsliced product during a cutting operation.

### CROSS-REFERENCE TO RELATED APPLICATIONS

This application is a US 371 Application from PCT/EP2018/056268 filed Mar. 13, 2018, which claims priority to GB Application No. 1703986.8 filed Mar. 13, 2017, the technical disclosures of which are hereby incorporated herein by reference.

### BACKGROUND OF THE INVENTION

### Technical Field

The present invention relates to a centrifugal-type slicer that provides for the commercial production of sliced food products. The present invention also relates to method for slicing food using such a centrifugal-type slicer.

### Description of Related Art

There are a number of methods for slicing food products as a pre-processing step to producing food products in the industry. Various machines and methods have been manufactured for the commercial production of ready-to-eat food products, such as potato or other vegetable or fruit chips, to produce chips of a variety of textures and sizes to appeal to the different preferences of consumers.

One such machine is a centrifugal-type slicer, such as the one disclosed in U.S. Pat. No. 5,694,824. As seen in FIG. 1, depicting the prior art, potatoes are fed through a feed hopper 10 onto an impeller 14 with inwardly extending partitions, which is surrounded by a stationary cutting head assembly 2. A motor (not pictured) rotates the impeller 14 via a gear box 16, creating a centrifugal force that causes the potatoes to move outwardly against generally radial paddles, forming partitions, and the inner surface of the cutting assembly. As further detailed in FIGS. 2 and 3, the cutting assembly includes a series of slicing shoes with cutting blades 22. The slicing shoe consists of a support 20 having a flat blade 22 attached with bolts 26. Each blade 22 is generally straight, having edges that fall within the same plane, and vertically oriented. Each straight blade 22 is attached at a front end of the support 20 by means of the bolts 26. A sand gate 71, also having a straight edge, is attached at a rear end of the support 20 to trap sand, dirt and other kinds of debris. In some embodiments the support is made of stainless steel, bronze, or plastic although other materials can also be used. In some embodiment the support 20 is made using a casting process or molding process, although other processes can also be used.

A centrifugal slicing machine, such as the one disclosed in U.S. Pat. No. 5,694,824, is manufactured and sold by Urschel Laboratories, Inc. of Valparaiso, Ind., USA. These machines allow for the production of sliced potatoes. For example, as shown in FIG. 4, an impeller 40, which includes generally radially oriented paddles 46, rotates in a direction 45 causing food product 42 to move against the flat interior walls 24, causing the straight blades 22 to create flat slices 44. As a result of centrifugal force, potatoes 42 are pushed against a stationary cutting head 2. The cutting head comprises blades 22 with vertically oriented cutting edges 25. Once a potato 42 contacts a cutting edge, a potato slice 44 will be cut in a direction that is essentially parallel to the plane of the blade. This is the cutting direction 47, which is substantially horizontal as shown in FIG. 4. As the product passes by the cutting blades of the slicing shoes, potato slices are quickly produced and passed on through a chute 18 for further processing into a ready-to-eat potato snack chips.

An improved centrifugal-type slicer is disclosed in US-A-2016/067877 and its equivalent WO-A-2016/036665. In the improved slicer, a standard interchangeable slicing shoe and its blade are modified to produce a blade that is angled relative to a normal plane to the cutting direction such that the cutting edge of the blade is not perpendicular to the direction the blade travels while cutting.

Such a blade configuration is shown in FIG. 5. The angled blade 50 is inclined at an acute angle α to a vertical plane V which contains the rotational axis of the impeller and the central axis of the cutting head containing the blade. Consequently, the blade 50 is oriented at an obtuse angle β to the direction D in which the vertical planar impeller paddle 52 pushes the food, illustrated as a potato P, against the blade 50.

The angled blade had been found to increase cutting yield, with reduced loss of starch, and has been found to reduce build-up of material on the blade. For example, this material can be debris, starch, or material from the products that are being cut. The buildup of this material can impede performance of the cutting blades, dull the cutting blades, and increase the damage done to sliced products as they are cut. Accordingly, the buildup of material on a blade can also result in a reduced yield.

However, the angled blade tends to cause a problem of feathering in the cut slices. Feathering is defined herein as the phenomenon of the cut slice being thinned at the edge or at the middle so as to have a non-uniform cross-section or thickness across the width of the slice. This phenomenon particularly occurs when cutting potato slices to form potato chips (crisps).

Consequently, there is a need for an improved method and apparatus for cutting food products on a commercial scale. In addition, there is a need to reduce, minimise or eliminate feathering of slices in conjunction with a high yield of sliced food product obtained from a given mass of the unsliced food product, low starch loss, long blade life and low or reduced buildup of material on the cutting blades. The present invention aims at least partially to meet this need.

### SUMMARY OF THE INVENTION

In a first aspect, the invention provides centrifugal-type slicer having a cutting head and an impeller, which impeller rotates unsliced food products against the cutting head in a direction of rotation for the production of sliced food products cut by the cutting head, wherein the cutting head has a central axis and the impeller has a rotational axis which is coincident with the central axis, the cutting head comprising a plurality of blades secured to the cutting head, which blades are arranged in a mutually spaced configuration around the central axis, and each blade comprises a cutting edge inwardly directed towards an interior of the cutting head and oriented to cut the food product as the food product rotates along the interior of the cutting head in a direction of rotation, and the impeller comprising a plurality of paddles which are arranged in a mutually spaced configuration around the rotational axis and are oriented substantially radially away from the rotational axis, each paddle having a front surface facing in the direction of rotation, which front surface is arranged to rotate the unsliced food products against the cutting head, wherein each cutting edge is inclined downwardly towards a bottom of the slicer at a first acute angle to a plane which contains the central axis and the rotational axis and is orthogonal to the direction of rotation, and each front surface is inclined downwardly towards the bottom of the slicer at a second acute angle to the plane, wherein the first and second angles are oriented at opposite directions relative to the plane.

In a second aspect the invention provides a centrifugal-type slicer having a cutting head and an impeller, which impeller rotates unsliced food products against the cutting head in a direction of rotation for the production of sliced food products, wherein the cutting head has a central axis, an interior, an exterior, a top, and a bottom, for slicing food product to form sliced food product, said cutting head comprising: at least one blade secured to the cutting head, wherein the at least one blade comprises a cutting edge inwardly directed towards the interior of the cutting head and oriented to cut the food product as the food product rotates along the interior of the cutting head in a direction of rotation, wherein a portion of the cutting edge comprises a plurality of first points, wherein for each first point in the plurality of first points, a corresponding first plane for the first point passes through the first point and contains the central axis, and wherein for each first point in the plurality of first points, as viewed from the central axis and along the corresponding first plane for the first point, a first tangent to the cutting edge at the first point is at a first angle to the corresponding first plane; and wherein the impeller has a rotational axis which is coincident with the central axis, and a plurality of paddles which are arranged in a mutually spaced configuration around the rotational axis and are oriented substantially radially away from the rotational axis, each paddle having a front surface facing in the direction of rotation, which front surface is arranged to rotate the unsliced food products against the cutting head, wherein a portion of the front surface comprises a plurality of second points, wherein for each second point in the plurality of second points, a corresponding second plane for the second point passes through the second point and contains the rotational axis, and wherein for each second point in the plurality of second points, as viewed from the rotational axis and along the corresponding second plane for the second point, a second tangent to the front surface at the second point is at a second angle to the corresponding second plane; wherein the first and second angles are oriented at opposite directions relative to a plane containing the central axis and the rotational axis.

In a third aspect the invention provides a method for making a sliced food product using a centrifugal-type slicer, said slicer having a cutting head and an impeller, which impeller rotates unsliced food products against the cutting head in a direction of rotation for the production of sliced food products cut by the cutting head, wherein the cutting head has a central axis and the impeller has a rotational axis which is coincident with the central axis, the cutting head comprising a plurality of blades secured to the cutting head, which blades are arranged in a mutually spaced configuration around the central axis, and each blade comprises a cutting edge inwardly directed towards an interior of the cutting head and oriented to cut the food product as the food product rotates along the interior of the cutting head in a direction of rotation, and the impeller comprising a plurality of paddles which are arranged in a mutually spaced configuration around the rotational axis and are oriented substantially radially away from the rotational axis, each paddle having a front surface facing in the direction of rotation, which front surface is arranged to rotate the unsliced food products against the cutting head, wherein each cutting edge is inclined downwardly towards a bottom of the slicer at a first acute angle to a plane which contains the central axis and the rotational axis and is orthogonal to the direction of rotation, and each front surface is inclined downwardly towards the bottom of the slicer at a second acute angle to the plane, wherein the first and second angles are oriented at opposite directions relative to the plane, said method comprising the steps of:

a) inserting a food product into said cutting head;
b) causing said impeller to rotate such that the food product is forced away from the rotational axis towards the interior of the cutting head and into contact with the front surface of a respective one of the paddles; and
c) while the food product is pushed in a rotational direction by the paddle, slicing the food product with a cutting edge of said at least one blade, thereby producing sliced food products, wherein the first and second angles are selected so that the paddle and the blade apply substantially equal and opposite turning forces on the unsliced food product during a cutting operation by the blade.

In a fourth aspect the invention provides a method for making a sliced food product using a centrifugal-type slicer, said slicer having an impeller with a rotational axis surrounded by a cutting head, wherein the cutting head has a central axis coincident with the rotational axis, an interior, an exterior, a top, and a bottom, for slicing food product to form sliced food product, said cutting head comprising: at least one blade secured to the cutting head, wherein the at least one blade comprises a cutting edge inwardly directed towards the interior of the cutting head and oriented to cut the food product as the food product rotates along the interior of the cutting head in a direction of rotation, and wherein the impeller has a plurality of paddles which are arranged in a mutually spaced configuration around the rotational axis and are oriented substantially radially away about the rotational axis, each paddle having a front surface facing in the direction of rotation, which front surface is arranged to rotate the unsliced food products against the cutting head, said method comprising the steps of:

d) inserting a food product into said cutting head;
e) causing said impeller to rotate such that the food product is forced away from the rotational axis towards the interior of the cutting head and into contact with the front surface of a respective one of the paddles; and
f) while the food product is pushed in a rotational direction by the paddle, slicing the food product with a cutting edge of said at least one blade, wherein the cutting edge is inwardly directed towards the impeller to slice the food product in a cutting direction at each first point along a length of the cutting edge when the food product is urged forwardly by a second point on the front surface of the paddle, and wherein a first tangent to the cutting edge is oriented at a first angle away from a normal plane to the cutting direction at each first point along a portion of the length of the cutting edge, and wherein a second tangent to the front surface is oriented at a second angle away from the normal plane to the cutting direction at each second point along a portion of the height of the front surface, thereby producing sliced food products.

The present invention is a method and apparatus for cutting food products. In preferred embodiments, the present invention provides the combination of a modified cutting head with an angled blade for slicing and a modified impeller with an angled impeller paddle, each angle being with respect to a cutting direction at which the food product is pushed by the impeller against the blade. The angled blade and angled impeller paddle are angled in opposite directions.

This structural arrangement has been found to provide the technical advantages of increased yield and reduced build-up of material on the blade as disclosed for an angled blade in US-A-2016/067877 and WO-A-2016/036665, but also avoids the problem of feathering. The combination of an angled blade and an angled impeller paddle, with the angled blade and angled impeller paddle being angled in opposite directions, has been found by the inventors to avoid or overcome the problem of feathering, and thus can provide cut slices which are of uniform cross-section or thickness across the width of the slice, avoiding slice thinning at the edge or centre of the slice, particularly when cutting potato slices to form potato chips (crisps).

Without being bound by any theory, the inventors believe that during the cutting operation the angle blade imparts a turning force on the food product, such as a potato, as the food product is being sliced. It is believed that the cutting force is applied unequally to the leading edge of the food product. This unequal cutting force caused the food product to turn in an anticlockwise direction, as shown in FIG. 5, about a turning axis extending through the food product, and hence to feather during slicing.

The addition of an angled impeller paddle, with the angled blade and angled impeller paddle being angled in opposite directions, is believed to substantially equal out the forces acting on the food product thereby preventing the food product from turning during slicing, about a turning axis extending through the food product, and therefore reducing the incidence of feathering during slicing, and statistically increasing the consistency of achieving a uniform and even slice thickness.

The provision of an angled blade reduces the force of cut and therefore reduces damage to the cells of the food product, such as a potato, which in turn leads to a lower loss of potato starch granules and a higher yield. However, it was found by the inventors that slice feathering increased when using the angled blades, as a result of the potato turning, about a turning axis extending through the food product, during slicing at the blade due to the forward angle on the blade exerting a lateral force on the top of the potato during the slicing process. As the potato turned, and due to the curvature of the slicer head, and therefore the curvature of the face of the potato being cut, the slice became feathered during the progress of the slice through the blade. The angled impeller paddle counteracts this force and prevents the potato from turning, about a turning axis extending through the food product, during the cutting process.

Moreover, the combination of the angled blades and the oppositely angled impeller paddles in the apparatus of the present invention has been found significantly to increase the yield of the potato slicing function by reduction of starch loss from the potatoes as compared to the use of a non-angled impeller paddle with an angled blade. The increase in yield, represented by a decrease in starch loss, is typically from 0.7 to 0.8 wt %. This is a significant yield benefit for an industrial potato chip manufacturing line which manufactures many thousands of tonnes of potato chips per annum.

### BRIEF DESCRIPTION OF THE DRAWINGS

Embodiments of the present invention will now be described by way of example only with reference to the following drawings, in which:

FIG. 1 is a partial side view of a known centrifugal slicing device with a known slicing head assembly;

FIG. 2 is a close-up view of a slicing shoe and blade in the device of FIG. 1;

FIG. 3 is a perspective view of the slicing head assembly of FIG. 1;

FIG. 4 is a partial, perspective view demonstrating the known slicing of food products using the known centrifugal slicing machine of FIG. 1;

FIG. 5 is a schematic side view of an impeller paddle and an angled blade during a cutting process in a known centrifugal slicing machine;

FIG. 6 is a perspective view of a stationary slicing head assembly for use with a centrifugal-type slicing machine for cutting vegetables into slices according to an embodiment of the present invention;

FIG. 7 is a side view of an interior of part of the stationary slicing head assembly of FIG. 6; and

FIG. 8 is a schematic plan view of an impeller in a centrifugal-type slicing machine according to an embodiment of the present invention which includes the stationary slicing head assembly of FIG. 6; and

FIG. 9 is a schematic side view of an angled impeller paddle and an angled blade during a cutting process in a centrifugal-type slicing machine according to an embodiment of the present invention which includes the stationary slicing head assembly of FIG. 6.

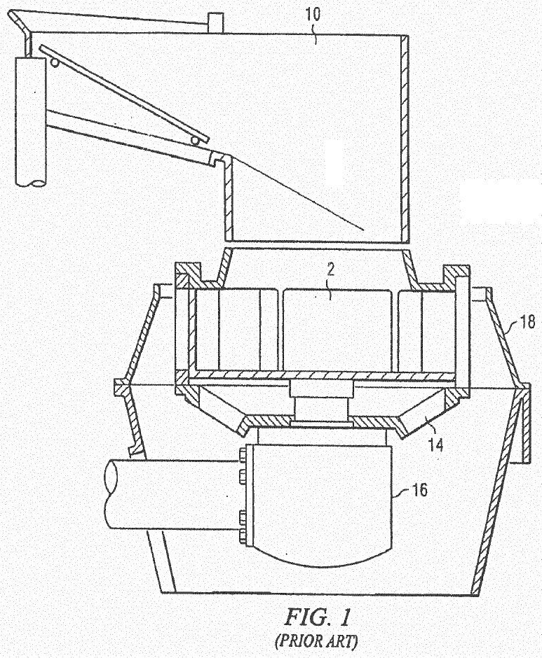

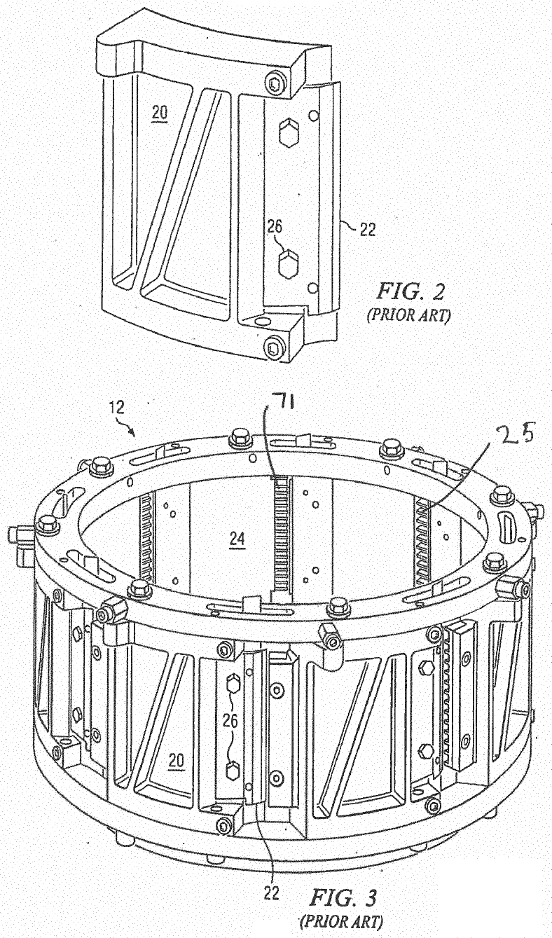

### DETAILED DESCRIPTION OF THE INVENTION

The accompanying figures are schematic and are not intended to be drawn to scale. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

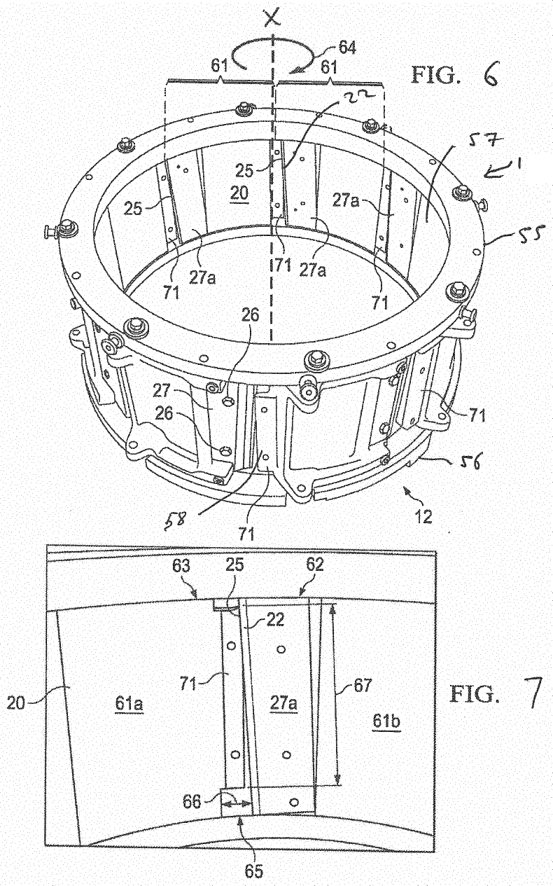

FIGS. 6 to 9 illustrate a centrifugal slicer according to a first embodiment of the invention. In particular, FIGS. 6 and 7 depict a cutting head 12 with angled blades which is incorporated in the centrifugal slicer. The cutting head 12 is the same cutting head as disclosed in US-A-2016/067877 and its equivalent WO-A-2016/036665.

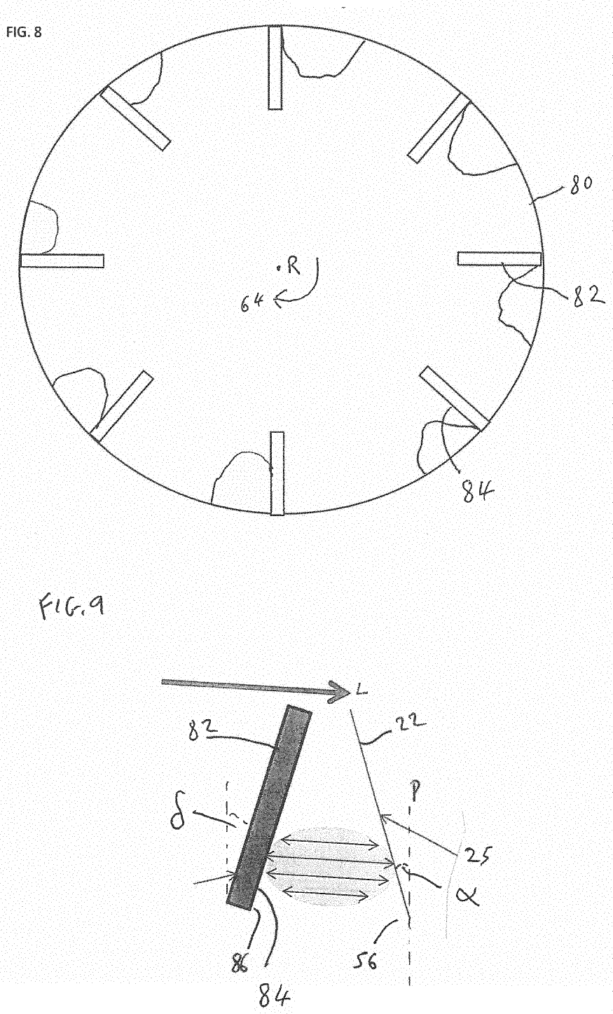

FIG. 6 shows a perspective view of cutting head 12 in a centrifugal-type slicer having the cutting head 12 and an impeller, which impeller rotates unsliced food products against the cutting head 12 in a direction of rotation 64 for the production of sliced food products cut by the cutting head 12. The cutting head 12 has a central axis X and the impeller has a rotational axis R, shown in FIG. 8, which is coincident with the central axis X. The cutting head 12 is cylindrical and stationary, but in other embodiments the cutting head 12 may rotate in the same or opposite direction to the impeller. The cutting head 12 has a top 55, bottom 56, interior 57 and exterior 58.

The cutting head comprises slicing shoes 61 arranged in a spaced relation to one another to form a generally cylindrical shape for placement around a rotatable impeller (not shown) of a centrifugal-type slicing machine having the axis of rotation 64. As shown in FIG. 6, the slicing shoes 61 are interchangeable. The cutting head assembly thus comprises a plurality of slicing shoes, with a first end of each shoe positioned adjacent to a second end of a juxtaposed slicing shoe.

The cutting head 12 comprises a plurality of knife blades 22 secured to the cutting head 12, which blades 22 are arranged in a mutually spaced configuration around the central axis X, and each blade 22 comprises a cutting edge 25 inwardly directed towards the interior 57 of the cutting head 12 and oriented to cut the food product as the food product rotates along the interior 57 of the cutting head 12 in the direction of rotation 64. The slicing shoes 61 are juxtaposed to form a gap 65. A first slicing shoe 61a comprises a second end 63, and a second slicing shoe 61b comprises a first end 62. The first end 62 comprises a knife blade 22, which, in turn, comprises cutting edge 25. The cutting edge 25 is positioned adjacent to the second end 63 of the first slicing shoe 61a to form a gap 65. The width of the gap 65 can be varied along its length to adjust the thickness of sliced product.

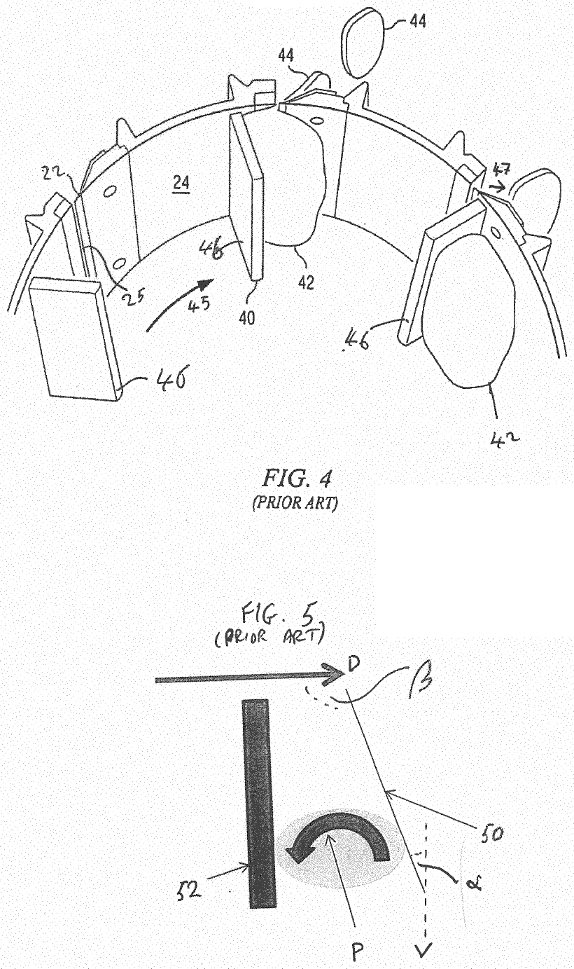

Referring to FIGS. 8 and 9, as also illustrated in FIG. 4, the impeller 80 comprises a plurality of paddles 82 which are arranged in a mutually spaced configuration around the rotational axis R. The paddles 82 are oriented substantially radially away from the rotational axis R. Each paddle 82 has a front surface 84 facing in the direction of rotation R, which front surface 84 is arranged to rotate the unsliced food products against the cutting head 12.

As shown in FIG. 9, each cutting edge 25 is inclined downwardly towards bottom 56 of the cutting head 12 of the centrifugal-type slicer at a first acute angle α to a plane P which contains the central axis X and the rotational axis R and is orthogonal to the direction of rotation 64. Each front surface 84 is inclined downwardly towards the bottom 86 of the impeller 80 of the centrifugal-type slicer at a second acute angle δ to the plane P. The first and second angles α, δ are oriented at opposite directions relative to the plane P.

The first and second angles α, δ are selected so that the paddle 82 and the blade 22 apply substantially equal and opposite turning forces on the unsliced food product during a cutting operation by the blade 22 so that the sliced food product has substantially parallel, sliced faces.

In the embodiment of FIGS. 6 to 9, the cutting edge 25 is linear and the entire cutting edge 25 is at a common first angle α to the plane P. Typically, the first angle α is from 8° to 45°, for example from 8 to 30°, optionally from 12 to 30°. In the embodiment of FIGS. 6 to 9, the front surface 84 is planar and the entire front surface 84 is at a common second angle δ to the plane P.

Typically, the second angle δ is from 8° to 45°, for example from 8 to 30°, optionally from 12 to 30°. The first and second angles α, δ are respectively positive and negative angles with respect to the common plane P containing the central and rotational axes X, R. The first angle α has a preset numerical value and the second angle δ has a numerical value that is within +/−10° of the preset value, optionally +/−5° of the preset value, further optionally +/−2° of the preset value, yet further optionally +/−1° of the preset value. This can provide a balanced angular relationship between the paddles and the blades. The first angle α and the second angle δ may have identical numerical values, but be in opposite directions relative to the common plane P containing the central and rotational axes X, R.

In alternative embodiments, only one blade 22 is provided in the cutting head 12 and/or only one impeller paddle 84 is provided in the impeller 80.

For consistency with the figures, the blades are described as vertically oriented and the cutting direction is referred to as horizontal; however, other orientations can be employed. For example, if the axis of rotation R were tilted, the blades would no longer be perfectly vertically oriented, but they would still be angled blades with respect to the cutting direction, which would also be titled by the same amount as the axis of rotation.

The blades may be flat blades, as shown in FIGS. 6 and 7, so that the flat blades produce flat slices, which in some cases contain some texture along the surface. For example, a blade having a number of waves or ridges along its cutting edge 25 produces either a wavy or ridged chip, respectively. Other blades can produce folded or curled shapes. However, all of these blades 22 have cutting edges 25 that are angled blades which are inclined to a cutting direction.

In the illustrated embodiment the cutting edge 25 is linear and the front surface 84 is planar. However, in other embodiments the cutting edge 25 is nonlinear, for example regularly or irregularly curved, and the front surface 84 is nonplanar, for example regularly or irregularly curved.

In alternative embodiments therefore, a portion of the cutting edge 22 comprises a plurality of first points, wherein for each first point in the plurality of first points, a corresponding first plane for the first point passes through the first point and contains the central axis X, and wherein for each first point in the plurality of first points, as viewed from the central axis X and along the corresponding first plane for the first point, a first tangent to the cutting edge 22 at the first point is at a first angle to the corresponding first plane. This provides that a portion of the cutting edge 22 of whatever geometrical shape is generally inclined downwardly relative to the central axis X.

Correspondingly, a portion of the front surface 84 comprises a plurality of second points, wherein for each second point in the plurality of second points, a corresponding second plane for the second point passes through the second point and contains the rotational axis R, and wherein for each second point in the plurality of second points, as viewed from the rotational axis R and along the corresponding second plane for the second point, a second tangent to the front surface 84 at the second point is at a second angle to the corresponding second plane. This provides that a portion of the front surface 84 of whatever geometrical shape is generally inclined relative to the rotational axis R. The first and second angles are oriented at opposite directions relative to a plane containing the central axis X and the rotational axis R.

The first and second angles are selected so that the paddle 82 and the blade 22 apply substantially equal and opposite turning forces on the unsliced food product during a cutting operation by the blade 22 so that the sliced food product has substantially parallel, sliced faces. Typically, the portion of the cutting edge 25 is less than an entire length of the cutting edge 25, greater than 50% of the cutting edge 25 and continuous. Preferably, for each first point along the portion of the cutting edge 22, the first angle is the same angle. Typically, the portion of the paddle 82 is less than a height of the paddle 82, greater than 50% of the height of the paddle and continuous. Preferably, for each second point along the portion of the paddle 82, the second angle is the same angle.

In the illustrated embodiment, the blade 22 is oriented downwardly toward the bottom 56 of the cutting head 12 and correspondingly the paddle 82 is oriented downwardly toward the bottom 86 of the impeller 80. However, in other embodiments the blade 22 and paddle 82 may be upwardly oriented.

For example, in FIGS. 6 and 7, the width 66 of the gap is widest at the bottom, gets narrower from bottom to top along a portion of the gap next to sand gate 71, and widens again at the top, although the gap is not as wide at the top as it is at the bottom. At some points along the gap, the sand gate 71 protrudes behind the cutting edge 25 and is not visible from the viewpoint shown in FIG. 7; however, even at these points, the gap is still present between the sand gate 71 and cutting edge 25 so that potato slices can pass through the gap as they are cut.

The angled blades 22 are curved to correspond to the curvature of the wall of the cutting head 12 so that the gap 65 between the cutting head 12 and the blade 22 does not vary in width 66 from top to bottom and results in a sliced product that has a substantially constant thickness. With a blade which is curved or arcuate, the cutting edge 25 can, for example, have a helical shape to provide a constant gap width along a length of the gap 65 (e.g., the length 67 of the gap 65 between the sand gate 71 and the cutting edge 25). In order to provide a constant gap width, it would also be useful to provide an angled sand gate 71.

Accordingly, one embodiment of the invention comprises a constant gap width of about 1.35 mm. In another embodiment, the gap width is from about 1.30 mm to about 1.40 mm. In another embodiment, the gap width is from about 1.2 mm to about 1.7 mm.

In another embodiment, the gap width is from about 0.025″ (0.635 mm) to about 0.250″ (6.35 mm). In another embodiment, the gap width is selected from any of the previously mentioned gap width ranges, or a range whose endpoints are formed by combining some combination of the end points of the previously mentioned gap width ranges, or a gap width that is contained by any of the previously mentioned gap width ranges.

Another embodiment comprises angled blades that are curved to match the curvature of walls on a cutting head.

Another embodiment comprises angled blades that are curved to provide a substantially constant gap width along a length 67 (e.g. along a portion or the entire length) of the gap 65.

Another embodiment comprises angled blades that are curved to produce product slices of substantially one thickness as measured from one sliced surface of the product to an opposite sliced surface of the product.

Another embodiment of the invention comprises blades with a helical curve.

In one embodiment, the blade 22 is flexible and is clamped to a slicing shoe (e.g., slicing shoe 61b). In one embodiment, a flexible blade 22 can take on a shape that approximates the curvature of the slicing shoe.

In some embodiments, a flexible blade 22 is clamped to a slicing shoe 61 to provide a constant gap width 66 along the length 67 of the gap 65 between the cutting edge 25 of the blade 22 and the support 20 at the second end 63 of an adjacent slicing shoe (e.g. the first slicing shoe 61a).

The knife blade 22 is removably secured to a first end of each slicing shoe 61. Each blade 22 can be secured to a slicing shoe by any means known in the art including but not limited to screws or bolts (e.g. bolts 26 of FIG. 6) having flat heads which fit through openings in a knife blade clamp 27 rigidly attaching the blade 22 to the front, interior side of the slicing shoes 61.

In some embodiments, the blade clamp 27 is positioned next to the exterior surface of the blade 22 while a blade holder 27a is positioned next to the interior surface of the blade 22. Together, the blade clamp 27 and blade holder 27a can hold a blade in position. In some embodiments, the blade clamp 27, blade holder 27a, or both are helical or shaped to match the curvature of a surface (e.g. interior surface) of the cutting head 12.

In some embodiments, a blade holder 27 and/or clamp 27a are attached to the support 20 of slicing shoe 61 and used to hold or clamp the cutting edge 25 of blade 22 into place so that the cutting edge protrudes past the interior surface of the slicing shoe 61.

One skilled in the art, armed with this disclosure will appreciate that any components used to secure (e.g. removably secure) the blade to a slicing shoe or cutting head 12 will conform to the shape of the cutting head 12. In the embodiment shown in FIGS. 6 and 7 the blades are flat and have a cutting edge that is a straight line.

In one embodiment, the blades have either a single or double bias/bevel cutting edge profile. A single bias cutting edge profile means the cutting edge has been provided by sharpening (e.g. by grinding) a blade on one side. Meanwhile, a double bias cutting edge profile means the cutting edge has been provided by sharpening a blade on two sides. For example, given a blade that is originally a rectangular prism, one edge can be given a single bias cutting edge profile by grinding one side of the edge. This grinding will form a cutting edge where the ground side meets the unground side.

As another example, a blade sharpened to provide a double bias cutting edge profile can be ground on both sides, and a cutting edge will be formed where the two ground sides meet.

In one embodiment, the shape of the blade clamps matches the shape of the blades. In some embodiments, the blade clamps are flat. Although in other embodiments, the blade clamps follow the wall of a cutting head assembly 12. For example, in one embodiment the cutting head assembly 12 is cylindrical and the blade clamps are helical to provide a constant gap width 66 between a cutting edge 25 and a slicing shoe 61a, which in turn provides slices 44 with parallel cuts on opposite faces.

The knife blade 22 comprises a cutting edge 25 that is angled away from vertical when viewed from the rotational axis 64 of the impeller. Because the blades 22 are angled, each blade takes up more horizontal space along the circumference of the cutting head 12 than the same blade would take up if it were vertically oriented.

Upon aligning the slicing shoes 61a, 61b around a generally circular array similar to that shown in FIG. 6, a second end 63 of a first slicing shoe 61a lines up correctly with a first end 62 of the adjacent second slicing shoe 61b so as to define a food slicing opening or gap 65, the size of which determines the thickness of a product slice.

Furthermore, in one embodiment, when slicing shoes 61a, 61b are aligned around a generally circular array, a first end 62 of each slicing shoe 61b comprises a knife blade (e.g., blade 22 of FIG. 6) with a cutting edge (e.g., cutting edge 25 of FIG. 7) positioned adjacent to a second end 63 of a juxtaposed slicing shoe 61a, which comprises a sand gate 71.

In some embodiments, a portion of the cutting edge is continuous. For example, the portion is a curve with no discontinuities. However, in some embodiments, the portion of the cutting edge is discontinuous. In other words, it is a curve with discontinuities. For example, if a cutting edge were a semi-circular shape, a point on the cutting edge can have a tangent to the cutting edge that is not at an angle to a plane. Furthermore, the point can separate two regions along the semi-circular cutting edge that both consist of a plurality of points on the cutting edge with tangents that are at an angle to the plane. Accordingly, the point is a discontinuity between two regions of the cutting edge that are at an angle to the plane. Thus, the portion of the cutting edge that comprises the regions has a discontinuity. Although, in some embodiments a discontinuous portion of the cutting edge has a single discontinuity, in some embodiments a discontinuous portion of the cutting edge has a plurality of discontinuities.

As another example, if a cutting edge were a serrated shape, each point in a first plurality of points on the cutting edge can have a tangent to the cutting edge that is at an angle to a plane, and these points can be separated by a second plurality of points, such that each point in the second plurality of points has a tangent to the cutting edge that is not at an angle to the plane. Furthermore, the second plurality of points can separate a plurality of angled regions along the cutting edge that consist of points from the first plurality of points. Accordingly, the points in the second plurality of points form discontinuities between the angled regions. Thus, the portion of the cutting edge that comprises the angled regions has discontinuities.

In some embodiments, to create food products with various sizes and shapes, blades having different shapes, widths and depths can be used with corresponding components to form the stationary cutting assembly. In other embodiments, a plurality of blades having the same or different shapes, widths, lengths and depths (or thicknesses) can be used with corresponding components to form the stationary cutting assembly. For example, in some embodiments, a blade can be smooth.

In other embodiments, a blade can be serrated.

In other embodiments, a blade can comprise curves, waves or ruffles, for example, to cut potato chips with corresponding shapes.

In some embodiments, a single blade comprises a shape that comprises a plurality of shape features, for example, some combination of shape features selected from the group of shape features consisting of curves, waves, and ruffles. In other embodiments, a single blade comprises a single shape feature.

In one embodiment, the slicing shoes of the present invention can be used with a centrifugal-type slicing system as disclosed above. In one embodiment, the slicing shoes and assembly of the present invention are utilized to conform to a centrifugal slicing system.

In one embodiment, the slicing shoes and cutting head assembly provide for an improved method of slicing food product with a centrifugal-type slicing machine. At least one food product is inserted into an impeller, which is caused to rotate such that the at least one food product is forced away from the axis of rotation due to centrifugal forces. The food product moves towards the interior wall surface of supports of said slicing shoes. The food product is then sliced by the angled cutting edges of the knife blades attached to the supports of the slicing shoes.

Using the centrifugal-type slicer of FIGS. 6 to 9, the impeller 80 rotates unsliced food products against the cutting head 12 in the direction of rotation 64 for the production of sliced food products cut by the cutting head 12. Each blade 22 comprises cutting edge 25 inwardly directed towards the interior 57 of the cutting head 12 and oriented to cut the food product as the food product rotates along the interior 57 of the cutting head 12 in the direction of rotation 64. The front surface 84 of each paddle 82 is arranged to rotate the unsliced food products against the cutting head 12.

At least one food product, such as a plurality of potatoes, is inserted into the cutting head 12. The impeller 80 is caused to rotate such that the at least one food product is forced away from the rotational axis R and towards the interior 57 of the cutting head 12 and into contact with the front surface 84 of a paddle 82.

While the food product is pushed in a rotational direction by the paddles 82, the at least one food product is sliced with a cutting edge 25 of said at least one blade 22, thereby producing sliced food products, wherein the first and second angles are selected so that the paddle 82 and the blade 22 apply substantially equal and opposite turning forces on the unsliced food product during a cutting operation by the blade 22. The substantially equal and opposite turning forces on the unsliced food product during the cutting operation in the slicing step typically prevent turning of the unsliced food product, about any turning axis extending through the food product, during the slicing step. Preferably, the substantially equal and opposite turning forces avoid or inhibit feathering so that the sliced food product has substantially parallel, sliced faces and a substantially constant thickness.

When cooked by means such as frying or baking, these food product slices result in ready-to-eat food products. Food products suitable for use with the present invention include without limitation any foodstuff, for example, cheese, produce, potatoes, apples, pears, beets, yucca, sweet potatoes, tomatoes, mangos, eggplants, cucumbers, zucchinis, etc. However, the present invention has particular application to cutting of potato slices for the manufacture of potato chips (crisps).

In one embodiment a slicing blade 22 impacts potatoes at 4.5 m/s. However, in other embodiments the impact speed can be higher or lower. For example, in some embodiments, the rotational velocity of the impeller 80 that rotates potatoes is from about 200 to about 265 rpm. In other embodiments, the rotational velocity is from about 200 to about 300 rpm. In some embodiments the diameter is about 355 mm, although the diameter can also be different sizes.

In one embodiment, the impact between a potato and a slicing blade 22 occurs near the cutting head wall (e.g., a distance before the wall if the cutting edge protrudes inside the cutting head).

Accordingly, in one embodiment, the impact velocity between the cutting edge and a potato is approximately equal to the translational velocity of the potato (e.g., the product of the distance from the potato to the axis of rotation times the rotational velocity of an impeller that rotates the potato).

In one embodiment the translational velocity (or impact velocity) of the potato when it impacts the cutting edge is about 3.7 m/s to about 4.9 m/s, about 4.0 m/s to about 4.5 m/s, or a range formed by combining any of the endpoints of the velocity ranges. In one embodiment, the translational velocity (or impact velocity) of the potato when it impacts the cutting edge is about 4.35 m/s. In some embodiments the invention allows the impact speed to be increased so that potatoes are cut more quickly while the yield is greater than it would otherwise be.

Although the yield should be decreased by increasing the impact speed, in some embodiments, the impact speed is increased, but the yield is not reduced or the yield is even increased.

In one embodiment, the relative speed of a potato to a cutting head and the relative cutting force on the cutting head can be reduced by co-rotating a cutting head 12 and an impeller 80 in the same direction. For example, in some embodiments, an angled cutting edge 25 can be used in combination with a cutting head 12 that rotates in the same direction as an impeller 80. Co-rotation of the cutting head 12 and the impeller 80 (and the potatoes inside the cutting head 12) can also decrease the speed at which potatoes impact the cutting head 12. Thus, co-rotation, for example, as described in U.S. Pat. No. 4,604,925 can be used with the angled cutting edges 25 described herein. However, as noted earlier, slowing down the relative velocity of the potatoes to the cutting head 122 can decrease throughput. Accordingly, it can still be desirable to use an angled cutting edge 25 without co-rotation of the impeller 80 and cutting head 12.

The present invention will now be illustrated further with reference to the following Example.

### Example 1

Potatoes were cut into slices of thickness about 1.35 mm using the apparatus of the illustrated embodiment of FIGS. 8 and 9 in which the blade and paddle were angled at first and second angles α, δ which were each at 12° relative to the plane P. The same first and second angles α, δ provided that the blade 22 and the paddle 82 and applied substantially equal and opposite turning forces on the potato product during the cutting operation by the blade 22 so that the potato slices had substantially parallel, sliced faces.

Moreover, the apparatus was found significantly to increase the yield of the potato slicing function by reduction of starch loss from the potatoes as compared to the use of a non-angled impeller with an angled blade as illustrated in FIG. 5. The increase in yield, represented by a decrease in starch loss, was from 0.7 to 0.8 wt %.

Various modifications to the illustrated embodiments of the invention will be readily apparent to those skilled in the art.

1. A centrifugal-type slicer having a cutting head and an impeller, which impeller rotates unsliced food products against the cutting head in a direction of rotation for the production of sliced food products cut by the cutting head, wherein the cutting head has a central axis and the impeller has a rotational axis which is coincident with the central axis,
the cutting head comprising a plurality of blades secured to the cutting head, which blades are arranged in a mutually spaced configuration around the central axis, and each blade comprises a cutting edge inwardly directed towards an interior of the cutting head and oriented to cut the food product as the food product rotates along the interior of the cutting head in a direction of rotation, and
the impeller comprising a plurality of paddles which are arranged in a mutually spaced configuration around the rotational axis and are oriented substantially radially away from the rotational axis, each paddle having a front surface facing in the direction of rotation, which front surface is arranged to rotate the unsliced food products against the cutting head,
wherein each cutting edge is inclined downwardly towards a bottom of the slicer at a first acute angle to a plane which contains the central axis and the rotational axis and is orthogonal to the direction of rotation, and each front surface is inclined downwardly towards the bottom of the slicer at a second acute angle to the plane, wherein the first and second angles are oriented at opposite directions relative to the plane.

2. The centrifugal-type slicer of claim 1, wherein the first and second angles are selected so that the paddle and the blade apply substantially equal and opposite turning forces on the unsliced food product during a cutting operation by the blade so that the sliced food product has substantially parallel, sliced faces.

3. The centrifugal-type slicer of claim 1, wherein the cutting edge is linear and the entire cutting edge is at a common first angle to the plane.

4. The centrifugal-type slicer of claim 1, wherein the first angle is from 8° to 45°.

5. (canceled)

6. The centrifugal-type slicer of claim 1, wherein the front surface is planar and the entire front surface is at a common second angle to the plane.

7. The centrifugal-type slicer of claim 1, wherein the second angle is from 8° to 45°.

8. (canceled)

9. The centrifugal-type slicer of claim 1, wherein the first and second angles are respectively positive and negative angles with respect to a common plane containing the central and rotational axes, and wherein the first angle has a preset numerical value and the second angle has a numerical value that is within +/−10° of the preset value.

10. (canceled)

11. A centrifugal-type slicer having a cutting head and an impeller, which impeller rotates unsliced food products against the cutting head in a direction of rotation for the production of sliced food products,
wherein the cutting head has a central axis, an interior, an exterior, a top, and a bottom, for slicing food product to form sliced food product, said cutting head comprising: at least one blade secured to the cutting head,
wherein the at least one blade comprises a cutting edge inwardly directed towards the interior of the cutting head and oriented to cut the food product as the food product rotates along the interior of the cutting head in a direction of rotation,
wherein a portion of the cutting edge comprises a plurality of first points,
wherein for each first point in the plurality of first points, a corresponding first plane for the first point passes through the first point and contains the central axis, and wherein for each first point in the plurality of first points, as viewed from the central axis and along the corresponding first plane for the first point, a first tangent to the cutting edge at the first point is at a first angle to the corresponding first plane; and
wherein the impeller has a rotational axis which is coincident with the central axis, and a plurality of paddles which are arranged in a mutually spaced configuration around the rotational axis and are oriented substantially radially away from the rotational axis, each paddle having a front surface facing in the direction of rotation, which front surface is arranged to rotate the unsliced food products against the cutting head,
wherein a portion of the front surface comprises a plurality of second points,
wherein for each second point in the plurality of second points, a corresponding second plane for the second point passes through the second point and contains the rotational axis, and
wherein for each second point in the plurality of second points, as viewed from the rotational axis and along the corresponding second plane for the second point, a second tangent to the front surface at the second point is at a second angle to the corresponding second plane;
wherein the first and second angles are oriented at opposite directions relative to a plane containing the central axis and the rotational axis.

12. The centrifugal-type slicer of claim 11, wherein the first and second angles are selected so that the paddle and the blade apply substantially equal and opposite turning forces on the unsliced food product during a cutting operation by the blade so that the sliced food product has substantially parallel, sliced faces.

13. The centrifugal-type slicer of claim 11, wherein the portion of the cutting edge is less than an entire length of the cutting edge, greater than 50% of the cutting edge and continuous.

14. The centrifugal-type slicer of claim 11, wherein for each first point along the portion of the cutting edge, the first angle is the same angle.

15. The centrifugal-type slicer of claim 11, wherein the cutting edge is linear and the entire cutting edge is at a common first angle to the first plane containing the central axis.

16. The centrifugal-type slicer of claim 11, wherein the first angle is from 8° to 45°.

17. (canceled)

18. The centrifugal-type slicer of claim 11, wherein the blade is oriented downwardly toward the bottom of the cutting head.

19. The centrifugal-type slicer of claim 11, wherein the portion of the paddle is less than a height of the paddle, greater than 50% of the height of the paddle and continuous.

20. The centrifugal-type slicer of claim 11, wherein for each second point along the portion of the paddle, the second angle is the same angle.

21. The centrifugal-type slicer of claim 11, wherein the front surface is planar and the front surface is at a common second angle to the second plane containing the rotational axis.

22. The centrifugal-type slicer of claim 11, wherein the second angle is from 8° to 45°.

23. (canceled)

24. The centrifugal-type slicer of claim 11, wherein the front surface is oriented downwardly toward the bottom of the cutting head.

25. The centrifugal-type slicer of claim 11, wherein the first and second angles are respectively positive and negative angles with respect to a common plane containing the central and rotational axes, wherein the first angle has a preset numerical value and the second angle has a numerical value that is within +/−10° of the preset value.

26. (canceled)

27. The centrifugal-type slicer of claim 11, wherein the cutting head is cylindrical and stationary, wherein the cutting head comprises a plurality of slicing shoes, wherein each slicing shoe comprises a blade, and wherein the slicing shoes are interchangeable.

28. A method for making a sliced food product using a centrifugal-type slicer, said slicer having a cutting head and an impeller, which impeller rotates unsliced food products against the cutting head in a direction of rotation for the production of sliced food products cut by the cutting head, wherein the cutting head has a central axis and the impeller has a rotational axis which is coincident with the central axis, the cutting head comprising a plurality of blades secured to the cutting head, which blades are arranged in a mutually spaced configuration around the central axis, and each blade comprises a cutting edge inwardly directed towards an interior of the cutting head and oriented to cut the food product as the food product rotates along the interior of the cutting head in a direction of rotation, and
the impeller comprising a plurality of paddles which are arranged in a mutually spaced configuration around the rotational axis and are oriented substantially radially away from the rotational axis, each paddle having a front surface facing in the direction of rotation, which front surface is arranged to rotate the unsliced food products against the cutting head,
wherein each cutting edge is inclined downwardly towards a bottom of the slicer at a first acute angle to a plane which contains the central axis and the rotational axis and is orthogonal to the direction of rotation, and each front surface is inclined downwardly towards the bottom of the slicer at a second acute angle to the plane, wherein the first and second angles are oriented at opposite directions relative to the plane, said method comprising the steps of:
a) inserting a food product into said cutting head;
b) causing said impeller to rotate such that the food product is forced away from the rotational axis towards the interior of the cutting head and into contact with the front surface of a respective one of the paddles; and
c) while the food product is pushed in a rotational direction by the paddle, slicing the food product with a cutting edge of said at least one blade, thereby producing sliced food products, wherein the first and second angles are selected so that the paddle and the blade apply substantially equal and opposite turning forces on the unsliced food product during a cutting operation by the blade.

29. The method of claim 28, wherein the substantially equal and opposite turning forces on the unsliced food product during a cutting operation in slicing step c) prevent rotation of the unsliced food product during slicing step c).

30. The method of claim 28, wherein the substantially equal and opposite turning forces avoid or inhibit feathering so that the sliced food product has substantially parallel, sliced faces and a substantially constant thickness.

31. The method of claim 28, wherein the cutting edge is linear and the entire cutting edge is at a common first angle to the plane.

32. The method of claim 28, wherein the first angle is from 8° to 45°.

33. (canceled)

34. The method of claim 28, wherein the front surface is planar and the entire front surface is at a common second angle to the plane.

35. The method of claim 28, wherein the second angle is from 8° to 45°.

36. (canceled)

37. The method of claim 28, wherein the first and second angles are respectively positive and negative angles with respect to a common plane containing the central and rotational axes.

38. The method of claim 28, wherein the first angle has a preset numerical value and the second angle has a numerical value that is within +/−10° of the preset value.

39. A method for making a sliced food product using a centrifugal-type slicer, said slicer having an impeller with a rotational axis surrounded by a cutting head, wherein the cutting head has a central axis coincident with the rotational axis, an interior, an exterior, a top, and a bottom, for slicing food product to form sliced food product, said cutting head comprising: at least one blade secured to the cutting head, wherein the at least one blade comprises a cutting edge inwardly directed towards the interior of the cutting head and oriented to cut the food product as the food product rotates along the interior of the cutting head in a direction of rotation, and wherein the impeller has a plurality of paddles which are arranged in a mutually spaced configuration around the rotational axis and are oriented substantially radially away about the rotational axis, each paddle having a front surface facing in the direction of rotation, which front surface is arranged to rotate the unsliced food products against the cutting head, said method comprising the steps of:
a) inserting a food product into said cutting head;
b) causing said impeller to rotate such that the food product is forced away from the rotational axis towards the interior of the cutting head and into contact with the front surface of a respective one of the paddles; and
c) while the food product is pushed in a rotational direction by the paddle, slicing the food product with a cutting edge of said at least one blade, wherein the cutting edge is inwardly directed towards the impeller to slice the food product in a cutting direction at each first point along a length of the cutting edge when the food product is urged forwardly by a second point on the front surface of the paddle, and wherein a first tangent to the cutting edge is oriented at a first angle away from a normal plane to the cutting direction at each first point along a portion of the length of the cutting edge, and wherein a second tangent to the front surface is oriented at a second angle away from the normal plane to the cutting direction at each second point along a portion of the height of the front surface, thereby producing sliced food products.

40. The method of claim 39, wherein the first and second angles are selected so that the paddle and the blade apply substantially equal and opposite turning forces on the unsliced food product during a cutting operation by the blade so that the sliced food product has substantially parallel, sliced faces, and wherein the substantially equal and opposite turning forces on the unsliced food product during a cutting operation prevent rotation of the unsliced food product during a cutting operation.

41. (canceled)

42. The method of claim 39, wherein the portion of the cutting edge is less than an entire length of the cutting edge, greater than 50% of the cutting edge and continuous.

43. The method of claim 39, wherein for each first point along the portion of the cutting edge, the first angle is the same angle.

44. The method of claim 39, wherein the cutting edge is linear and the entire cutting edge is at a common first angle to the first plane containing the central axis.

45. The method of claim 39, wherein the first angle is from 8° to 45°.

46. (canceled)

47. The method of claim 39, wherein the blade is oriented downwardly toward the bottom of the cutting head.

48. The method of claim 39, wherein the portion of the paddle is less than a height of the paddle, greater than 50% of the height of the paddle and continuous.

49. The method of claim 39, wherein for each second point along the portion of the paddle edge, the second angle is the same angle.

50. The method of claim 39, wherein the front surface is planar and the front surface is at a common second angle to the second plane containing the rotational axis.

51. The method of claim 39, wherein the second angle is from 8° to 45°.

52. (canceled)

53. The method of claim 39, wherein the front surface is oriented downwardly toward the bottom of the cutting head.

54. The method of claim 39, wherein the first and second angles are respectively positive and negative angles with respect to a common plane containing the central and rotational axes, wherein the first angle has a preset numerical value and the second angle has a numerical value that is within +/−10° of the preset value.

55. (canceled)

56. The method of claim 39, wherein the cutting head is cylindrical and stationary, wherein the cutting head comprises a plurality of slicing shoes, wherein each slicing shoe comprises a blade, and wherein the slicing shoes are interchangeable.
